(19) United States
(12) Patent Application Publication
(10) Pub. No.: US 2015/0196166 A1
(43) Pub. Date: Jul. 16, 2015

(54) CUTTING FORCE DISPERSING CUTTING MAT

(71) Applicant: Chi-Jen CHEN, Xihu Township (TW)

(72) Inventor: Chi-Jen CHEN, Xihu Township (TW)

(21) Appl. No.: 14/156,073

(22) Filed: Jan. 15, 2014

(51) Int. Cl. A47J 47/00; B32B 5/18

(52) U.S. Cl. CPC A47J 47/005; B32B 5/18; B32B 2250/05; B32B 2307/581; B32B 2307/56

(57) ABSTRACT

A cutting mat for dispersing cutting force has an entity which comprises of at least an elastic buffer substrate which tan disperse the cutting force, two anti-puncture layers at the top and bottom of the elastic buffer substrate respectively, and two cutting close binders at the top and bottom of two anti-puncture lavers respectively. The entity is a multi-layer structure of at least five layers, and the thickness of said elastic buffer substrate is greater than single anti-puncture layer and single cutting close binder. Therefore, the user uses a cutter for downward cutting on the surface of the cutting close binder, the down pressure force is dispersed and absorbed by the elastic buffer substrate. In long-term repeated cutting action, the cut object on the cutting close binder can be cut off easily without damaging the entity, so as to enhance the service life and convenience of products greatly.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable

### BACKGROUND OF THE INVENTION

1. Field of the Invention

The present invention relates generally to a cutting mat, and more particularly to a cutting mat which has the function of dispersing cutting force.

2. Description of Related. Art Including Information Disclosed Under 37 CFR 1.97 and 37 CFR 1.98

A cutting mat is used to avoid cutting the tabletop when cutting articles. It is put under the cut object, so that the user can cut on the cutting mat surface to attain said purpose.

The known universal cutting mat 01 structure, as shown in FIG. 1, is a mostly rigid single-ply plate, and certainly obstructs the cut object and prevents the tabletop from being cut. However, the defect in the known cutting mat 01 structure is shown in FIG. 2. When the user uses a cutter 02 (e.g. a cutting disc) for cutting on the surface of cutting mat 01, as the cutting mat 01 is not designed with any butter structure, it cannot absorb or disperse the external pressure force (see arrow F1). Therefore, the reaction force generated by the cutting mat during cutting is completed fed back to the cutting mat surface (see arrow F2, i.e. the cutter contacts the cutting mat directly). A long-term repeated cutting action is likely to cut off the cutting mat, resulting in breakage, so that the lifetime of cutting mat is shortened greatly, and the consumer's willingness to use is reduced greatly.

Thus, to overcome said problems of the prior art, it would be an advancement if the art to provide an improved structure that can significantly improve the efficacy.

Therefore, the inventor has provided the present invention of practicability after deliberate design and evaluation based on years of experience in the production, development and design of related products.

### BRIEF SUMMARY OF THE INVENTION

The cutting mat with the function of dispersing cutting force revealed in the present invention is a multi-layer structure of at least five layers composed of an elastic buffer substrate, two anti-puncture layers and two cutting close binders. In comparison to previous technologies, when the user uses a cutter for downward cutting on the surface of cutting close binder, the down pressure force is dispersed and absorbed by the elastic buffer substrate, so that the reaction force generated by the entity will not be completely fed back to the surface of cutting close binder. Therefore, in long-term repeated cutting action, the cut object on the cutting close binder can be cut off easily without damaging the entity. Therefore, the present invention can improve the practical evolutionarities of products greatly, such as service life, convenience and consumer willingness to use.

Although the invention has been explained in relation to its preferred embodiment, it is to be understood that many other possible modifications and variations can be made without departing from the spirit and scope of the invention as hereinafter claimed.

### BRIEF DESCRIPTION OF THE SEVERAL VIEWS OF THE DRAWINGS

FIG. 1 is a perspective view of the known cutting mat.

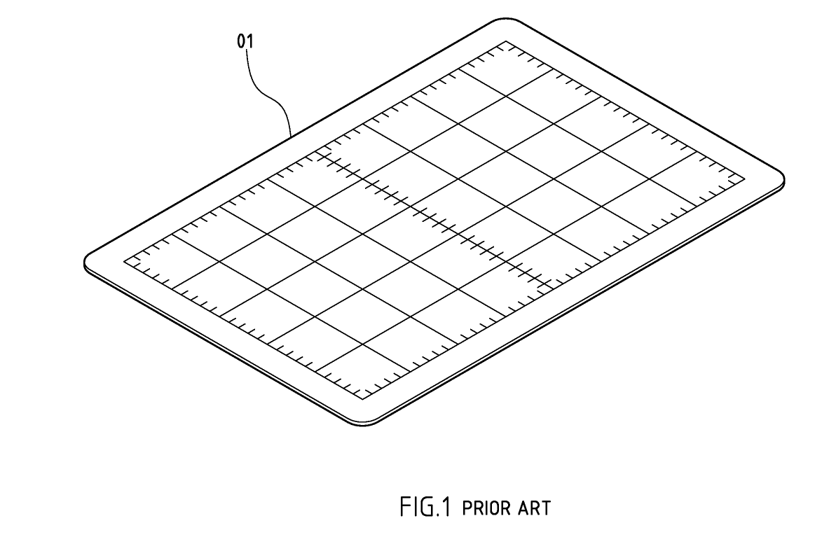

FIG. 2 is a reference diagram showing the operating conditions of the known cutting mat.

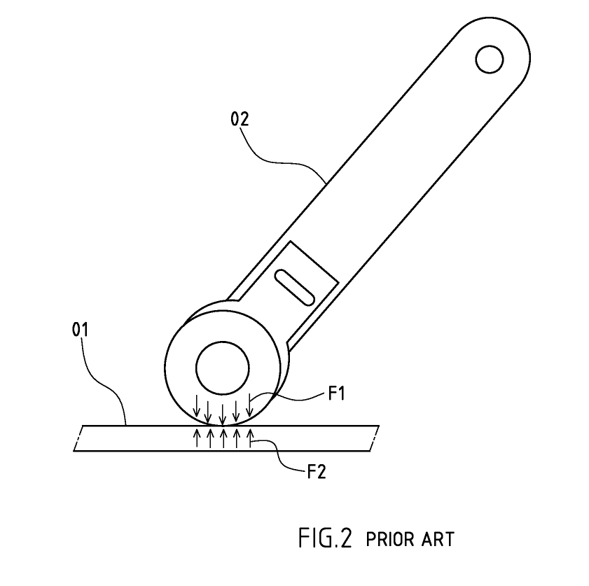

FIG. 3 is a perspective view of the present invention.

FIG. 4 is a broken-out section view of various layers of the present invention.

FIG. 5 is a reference diagram showing operating conditions of the present invention.

### DETAILED DESCRIPTION OF THE INVENTION

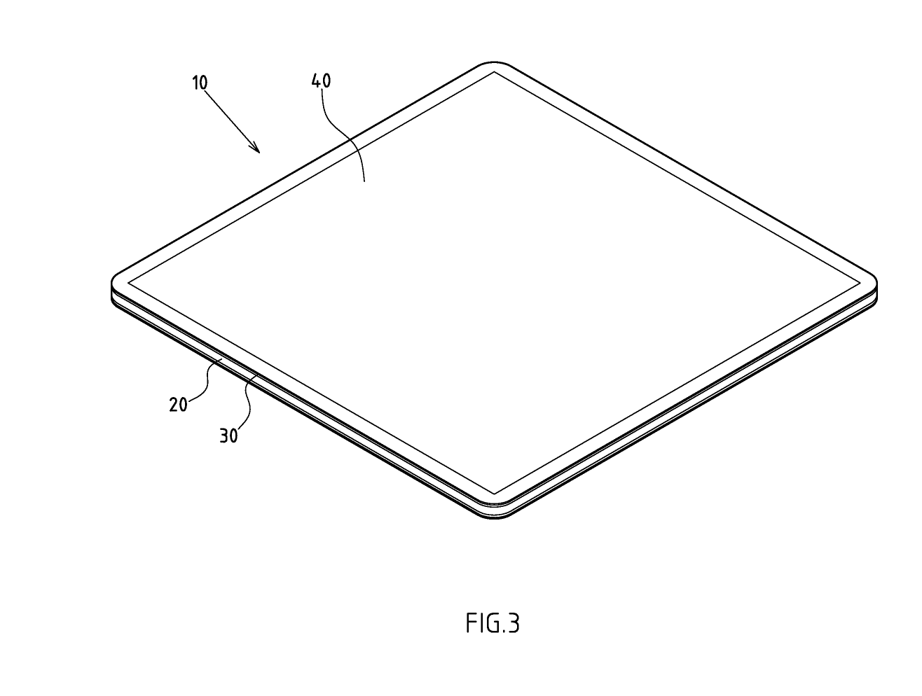

Please refer to FIG. 3 to FIG. 5, which show the preferred embodiments of this cutting mat with the function of dispersing cutting force. The embodiments are for illustration only, not limited to this structure in patent application. Said Cutting mat comprises of an entity 10, the entity 10 comprising an elastic buffer substrate 20 which can disperse the cutting force, two anti-puncture layers 30 at the top and bottom of the elastic buffer substrate 20 respectively, and two cutting close binders 40 at the top and bottom of two anti-puncture lavers 30 (PVC material, but not limited to this). Let the entity 10 be a multi-layer structure of at least five layers, and it can be turned Over (the uppermost layer and the bottommost layer are cutting close binder 40).

The thickness of said elastic buffer substrate 20 must be greater than single anti-puncture layer 30 and single cutting close binder 40. In addition, the material of the elastic buffer substrate 20 is preferred to be soft foam material or soft rubber material. Other materials like flexible plastics can be used for the present invention, and this part is not limited.

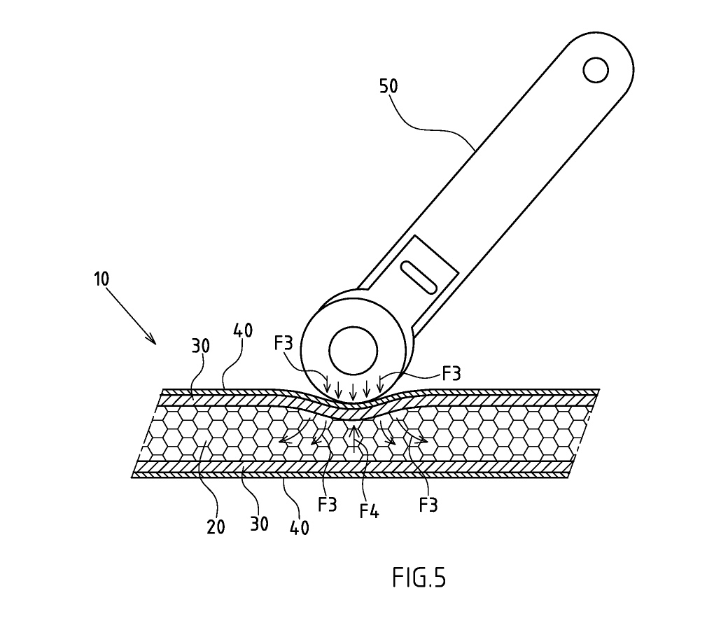

Based on said structure, when the user uses a cutter 50 for downward cutting on the surface of cutting close binder 40 the down pressure force (see arrow F3 in FIG. 5) can he dispersed and absorbed b the elastic buffer substrate 20, so that the reaction force generated by the entity 10 (see arrow F4 in FIG. 5) will not be completely fed back to the surface of cutting close binder 40. Therefore, in long-term repeated cutting action, the cut object on the cutting close binder 40 can be cut off easily without penetrating or damaging the entity 10. Said cutter 50 can be a cutting disc or a utility knife. This embodiment uses cutting disc, and the present invention has more obvious effect on cutting disc. Therefore, in comparison to the known bard single-ply cutting mat 01 structure, the present invention can improve the practical evolutionarities of products greatly, such as lifetime, convenience and consumer willingness.

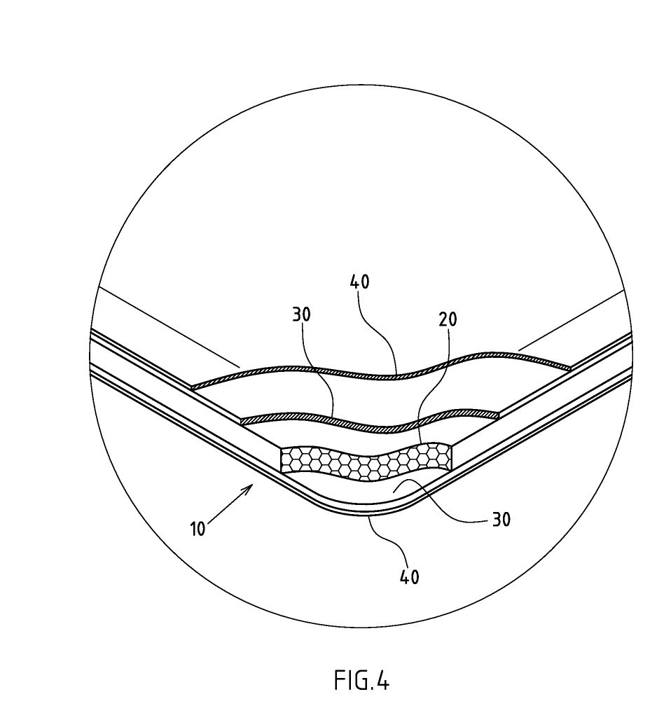

As shown in FIG. 4, the thickness of the elastic buffer substrate 20 can be 3-5 mm in the implementation of the present invention, the thickness of single anti-puncture layer 30 is 1-2 mm, and the thickness of single cutting close binder 40 is 0.3-0.5 mm. The structural thickness of various layers is preferred to be within said ranges, but not limited to them.

1. A cutting mat with the function of dispersing cutting force, said cutting mat has an entity which comprises of at least:
an elastic buffer substrate which can disperse the cutting force, two anti-puncture layers at the top and bottom of the elastic huller substrate respectively and two cutting close binders at the top and bottom of two anti-puncture layers respectively; the entity is a multi-layer structure of at least five layers, and the thickness of said elastic buffer substrate must be greater than single anti-puncture layer and single cutting close binder;
therefore, when the user uses a cutter for downward cutting on the surface of cutting close binder, the down pressure force is dispersed and absorbed by the elastic buffer substrate, so that the reaction force generated b the entity will not be completely fed back to the surface of cutting close binder; in long-term repeated cutting action, the cut object on the cutting dose binder can be cut off easily without damaging the entity, so as to enhance the service life and convenience of products greatly.

2. The structure defined in claim 1, wherein the thickness of the elastic buffer substrate is 3-5 mm, the thickness of single anti-puncture layer is 1-2 mm, and the thickness of single cutting close binder is 0.3-0.5 mm.

3. The structure defined in claim 1, wherein the elastic buffer substrate is made of soft foam material or soft rubber material.

4. The structure defined in claim 3, wherein said cutter is a cutting disc or a utility knife.
